(19) United States
(12) Patent Application Publication
(10) Pub. No.: US 2022/0230101 A1
(43) Pub. Date: Jul. 21, 2022

(54) SYSTEMS, DEVICES, AND METHODS FOR MODIFYING A QUEUE ARRANGEMENT

(71) Applicant: GYM SOCIAL LLC, Sammamish, WA (US)

(72) Inventors: Michel R. GAHARD, Kirkland, WA (US); Angela Z. TROY, Renton, WA (US)

(73) Assignee: GYM SOCIAL LLC, Sammamish, WA (US)

(21) Appl. No.: 17/715,712

(22) Filed: Apr. 7, 2022

Related U.S. Application Data
(63) Continuation of application No. PCT/US2020/054521, filed on Oct. 7, 2020.
(60) Provisional application No. 62/912,062, filed on Oct. 8, 2019.

(51) Int. Cl. G06Q 10/02; G06F 9/451

(52) U.S. Cl. CPC G06Q 10/02; G06F 9/451

(57) ABSTRACT

Systems, devices, and methods are described for accessing and managing a virtual queue for an event or services. In an embodiment, the system includes a queue unit including computational circuitry configured to generate a queue status associated with an event and to present a queue modification menu including one or more instances of a priority level choice. In an embodiment, the system includes a queue controller including computational circuitry configured to modify a virtual queue arrangement of a plurality of users associated with the event responsive to receiving one or more inputs indicative of a user priority level choice. In an embodiment, the system includes an outsource unit configured to broadcast a request to purchase a placement in the virtual queue.

### RELATED PATENT APPLICATIONS

This application is a continuation of PCT/US2020/054521, filed on Oct. 7, 2020, and published as WIPO Publication No. WO 2021/071906 A1 on Apr. 15, 2021, entitled Systems, Devices And Methods For Modifying A Queue Arrangement. That PCT application claimed priority under 35 USC. § 119(e) from U.S. Provisional Patent Application Ser. No. 62/912,062 filed on Oct. 8, 2019 entitled Systems, Devices And Methods For Modifying A Queue Arrangement. The disclosures of each of PCT/US2020/054521 and U.S. Provisional Application Ser. No. 62/912,062, are incorporated herein in their entirety including the specification, drawing, and claims, by this reference.

### STATEMENT OF GOVERNMENT INTEREST

Not Applicable.

### COPYRIGHT RIGHTS IN THE DRAWING

A portion of the disclosure of this patent document contains material that is subject to copyright protection. The patent owner has no objection to the facsimile reproduction by anyone of the patent document or the patent disclosure, as it appears in the Patent and Trademark Office patent file or records, but otherwise reserves all copyright rights whatsoever

### TECHNICAL FIELD

This disclosure is recited to systems for sorting priority of users or purchasers for limited availability events or services, and in various embodiments, determining queue placement and event or services pricing.

### BACKGROUND

Many different types of events or services are faced with the issue of when and how to allocate available slots for such events or services. And, providers of events or services are also faced with timing of consummating the sale, whether by tickets or otherwise, in a fashion that would facilitate efficient capture of revenue at optimum pricing for the provider of the events or services. Thus, there is a continuing and as yet unmet need for a highly efficient system which appropriately prioritizes potential purchasers of services, or of event tickets, or the like, in a manner which recognizes selected priorities, whether by loyalty (e.g. airline mileage program status), price point (e.g., potential customers that indicate a willingness to purchase coach, business, or first class tickets), or other selected criteria. It would be advantageous if such a system were provided that efficiently provides such sorting and prioritization service, and, where appropriate, while maximizing sales prices for the provider of the event or services.

### SUMMARY

In an aspect, the present disclosure is directed to, among other things, a system comprising a queue unit including computational circuitry configured to generate a queue status associated with an event and to present a queue modification menu including one or more instances of a priority level choice. In an embodiment, the system includes a queue controller including computational circuitry configured to modify a virtual queue arrangement of a plurality of users associated with the event responsive to receiving one or more inputs indicative of a user priority level choice. In an embodiment, the system includes an outsource unit configured to broadcast a request to purchase a placement in the virtual queue.

In an aspect, the present disclosure is directed to, among other things, a system comprising means for generating a queue status associated with an event and for presenting a virtual queue modification menu including one or more instances of a priority level choice. In an embodiment, the system includes means for modifying a virtual queue arrangement of a plurality of users associated with the event responsive to receiving a user priority level choice. In an embodiment, the system includes means for broadcasting a request to purchase a placement in the virtual queue.

In an aspect, the present disclosure is directed to, among other things, a method comprising presenting a virtual queue modification menu including one or more instances of a priority level choice. In an embodiment, the method includes modifying a virtual queue arrangement of a plurality of users associated with the event responsive to receiving the one or more inputs indicative of a user priority level choice. In an embodiment, the method includes receiving audio commands; and enabling one or more user priority level choices. In an embodiment, the method includes accepting inputted payment information associated with the user priority level choice. In an embodiment, the method includes generating a higher priority grouping; and electronically notify at least one member in the higher priority grouping the request to buy a placement in the virtual queue. In an embodiment, the method includes facilitating payment to a seller for an offer to sell the placement in the virtual queue based on one or more inputs indicative of a selection of a checkout URL associated with a virtual shopping cart. In an embodiment, the method includes generating a higher priority grouping; and electronically notify at least one member in the higher priority grouping the request to buy a placement in the virtual queue. In an embodiment, the method includes facilitating payment to a seller for an offer to sell the placement in the virtual queue based on one or more inputs indicative of a selection of a checkout URL associated with a virtual shopping cart.

In an aspect, the present disclosure is directed to, among other things, a method comprising generating a virtual queue arrangement of a plurality of users associated with an event. In an embodiment, the method includes communicating a virtual queue modification menu including one or more instances of a priority level choice. In an embodiment, the method includes receiving one or more inputs indicative of a user priority level choice. In an embodiment, the method includes modifying a virtual queue arrangement of a plurality of users associated with the event responsive to receiving the one or more inputs indicative of a user priority level choice. In an embodiment, the method includes modifying the virtual queue arrangement of one or more of the plurality of users associated with the event responsive to receiving the one or more inputs indicative of an acceptance to an offer to sell a placement in the virtual queue. In an embodiment, the method includes broadcasting a request to purchase a placement in the virtual queue. In an embodiment, the method includes broadcasting to one or more client devices the request to purchase a placement in the virtual queue.

In an aspect, the present disclosure is directed to, among other things, a method comprising generating a higher priority grouping for a plurality of users associated with the event; and electronically notifying at least one member in the higher priority grouping a request to buy a placement in the virtual queue. In an embodiment, the method includes generating a higher priority grouping associated with the event; and electronically notifying at least one member in the higher priority grouping a request to buy a placement in the virtual queue. In an embodiment, the method includes facilitating payment to a digital wallet responsive to receiving one or more inputs indicative of transaction for a placement in the virtual queue.

### BRIEF DESCRIPTION OF THE DRAWING

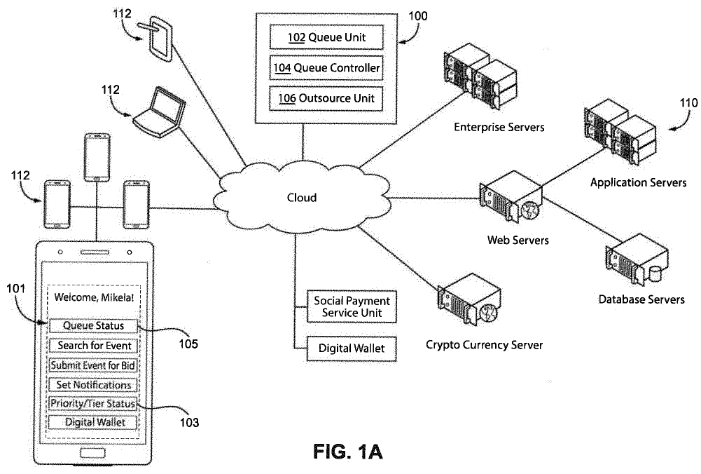

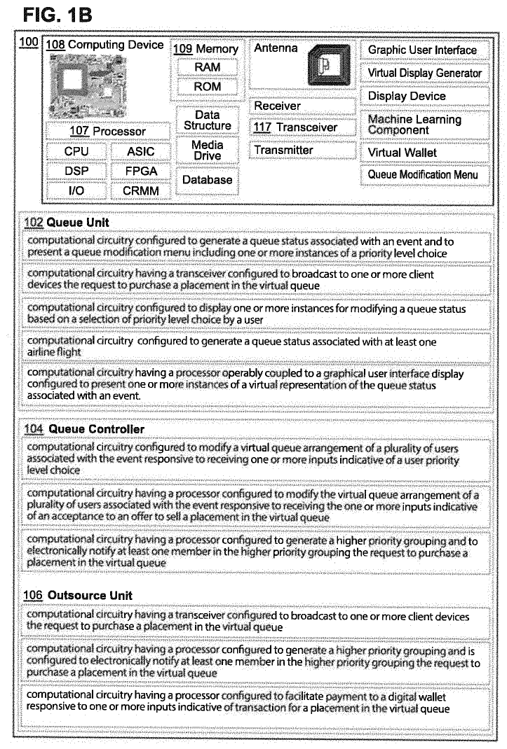

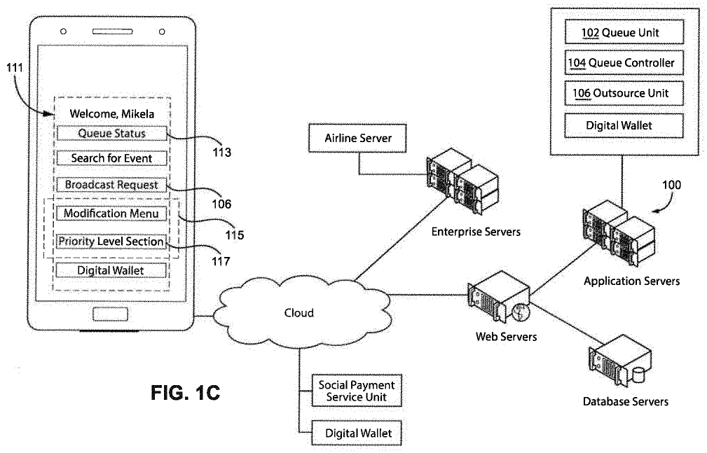

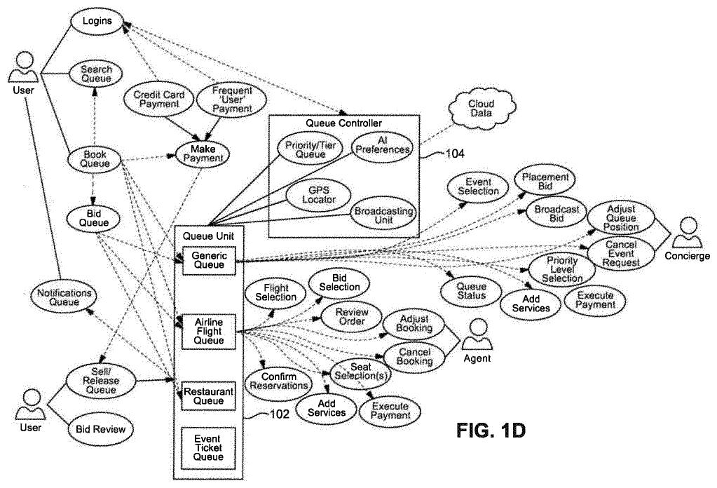

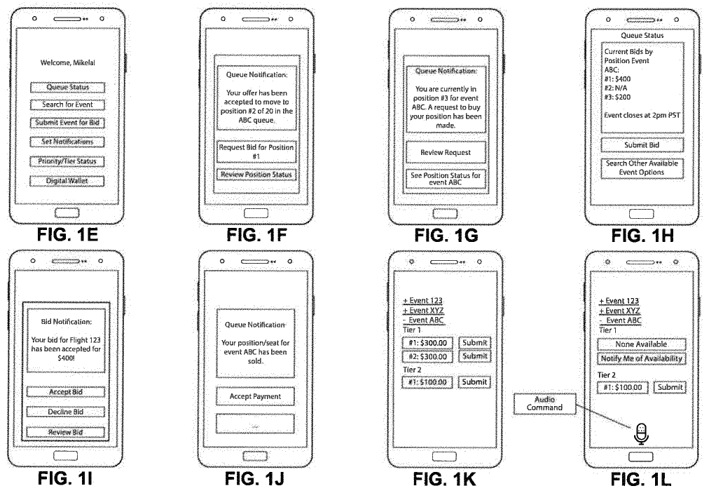

FIG. 1A is a schematic diagram of a system for accessing and managing a virtual queue for an event or services according one embodiment.

FIG. 1B is a schematic diagram of a system according one embodiment.

FIG. 1C is a schematic diagram of a system for managing a virtual queue according one embodiment.

FIG. 1D is a schematic diagram of a system according one embodiment.

FIGS. 1E-1L are schematic diagram of a system for managing a virtual queue according one or more embodiments.

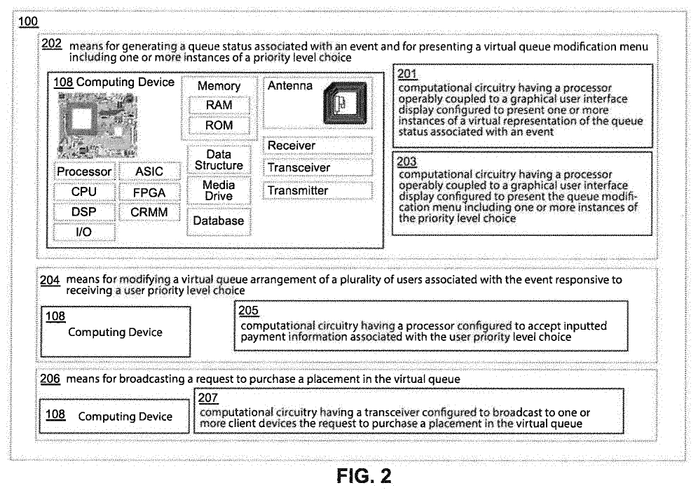

FIG. 2 is a schematic diagram of a system for modifying a virtual queue associated with an event according one embodiment.

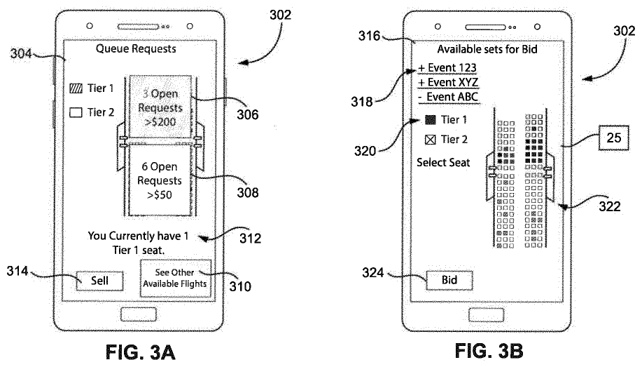

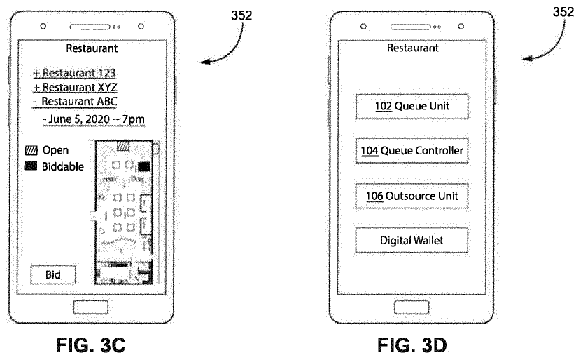

FIG. 3A is a schematic diagram of a system for accessing and managing a virtual queue for flights or airline services according one embodiment.

FIG. 3B is a schematic diagram of a system for accessing and managing a virtual queue for flights or airline services according one embodiment.

FIG. 3C is a schematic diagram of a system for accessing and managing a virtual queue for reservations or restaurant services according one embodiment.

FIG. 3D is a schematic diagram of a system for accessing and managing a virtual queue for reservations or restaurant services according one embodiment.

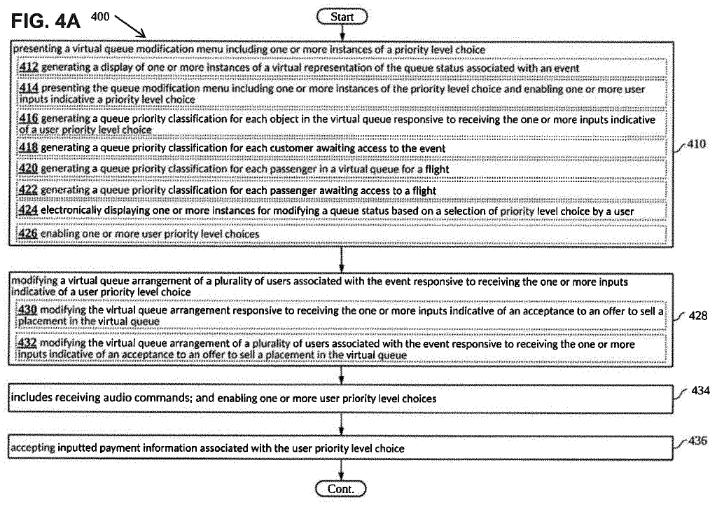

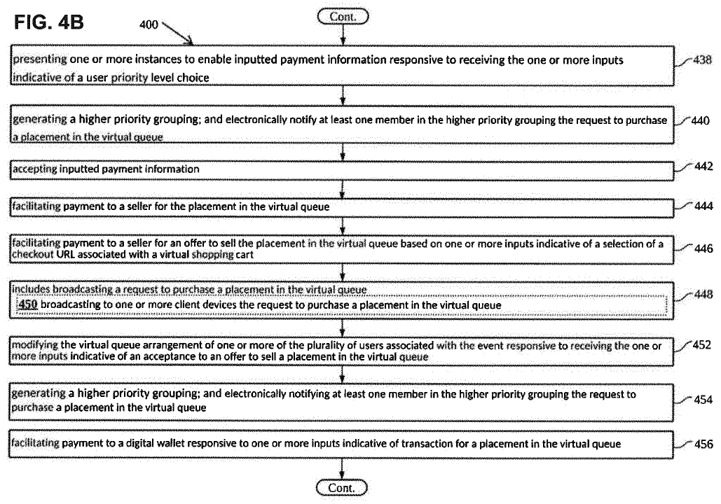

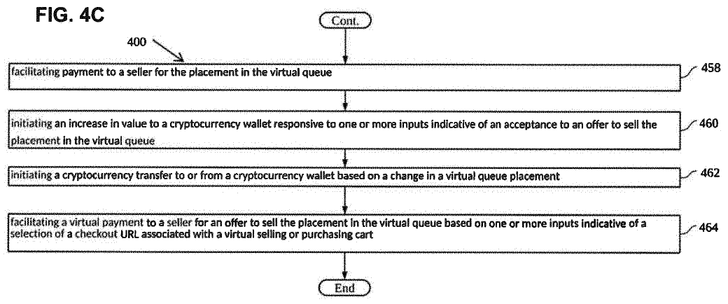

FIGS. 4A, 4B, and 4C show a flow diagram of a method according to one embodiment.

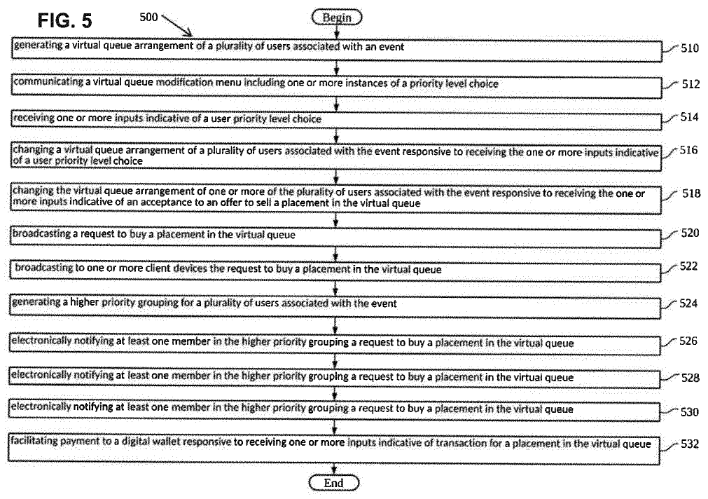

FIG. 5 shows a flow diagram of a method according to one embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here.

### DETAILED DESCRIPTION

There are many instances in which consumers need to access and manage their placement in a queue for an event or services. One such instance occurs when a flight is cancelled, and the affected passengers need to access, be placed in, and manage their placement in an alternate flight queue.

Flight delays and cancellations cost airlines $30 billion a year in lost revenue. Flight delays and cancellations also result in additional costs that are borne by the affected passengers trying to mitigate the disruption to their journey. In 2018, approximately 3.9 million flights worldwide were delayed by over 30 minutes or canceled, affecting over 470 million passenger journeys. This amounts to 10,700 delayed or cancelled flights per a day.¹ In moments like this, passengers find themselves with very few resources to mitigate the disruption to their journey. Rather than managing their own affairs, however, affected passengers typically rely on the airline for help. ¹ “Global Survey Shows Travelers Still Struggle with Lack of Information About Delayed and Cancelled Flights, Says Cirium.” PR Newswire: Press Release Distribution, Targeting, Monitoring and Marketing, Cirium, 8 Apr. 2019, https://www.prnewswire.com/in/news-releases/global-survey-shows-travellers-still-struggle-with-lack-of-information-about-delayed-and-cancelled-flights-says-cirium-868309007.html. Accessed 8 Sep. 2019.

Accordingly, FIGS. 1A-1L show a system 100 in which one or more methodologies or technologies can be implemented such as, for example, managing a virtual queue, modifying a queue arrangement associated with an event, generating an interface that allows access to a system used to enable end users to position themselves in a queue for various services, democratizing access to priority seating at an event, managing a waiting list for seating at a restaurant, or the like.

Referring to FIGS. 1A and 1B, in an embodiment, a system 100 comprises one or more queue units 102, queue controllers 104, and outsource units 106. In an embodiment, a queue unit 102 is configured to generate a queue status associated with an event and to present a queue modification menu including one or more instances of a priority level choice. In an embodiment, a queue controller 104 is configured to modify a virtual queue arrangement of a plurality of users associated with the event responsive to receiving one or more inputs indicative of a user priority level choice. In an embodiment, an outsource unit 106 is configured to broadcast a request to purchase a placement in the virtual queue.

Referring to FIGS. 1A, 1B, 1C, and 1D, in an embodiment, a system 100 comprises a queue unit 102. In an embodiment, the queue unit 102 is configured to generate a queue status associated with an event and to present a queue modification menu 101 including one or more instances of a priority level choice 103. For example, in an embodiment, the queue unit 102 includes computational circuitry configured to generate a queue status 105 associated with an event and to present a queue modification menu 101 including one or more instances of a priority level choice 103 responsive to receiving one or more inputs indicative of a user request for placement in the queue for the event.

In an embodiment, circuitry includes, among other things, one or more computing devices 108 such as a processor 107 (e.g., a microprocessor, and the like), a central processing unit (CPU), a digital signal processor (DSP), an application-specific integrated circuit (ASIC), field programmable gate array (FPGA), or the like, or any combinations thereof, and can include discrete digital or analog circuit elements or electronics, or combinations thereof. In an embodiment, circuitry includes one or more ASICs having a plurality of predefined logic components. In an embodiment, circuitry includes one or more FPGAs having a plurality of programmable logic components.

In an embodiment, circuitry includes one or more electrical components operably coupled (e.g., communicatively, electromagnetically, magnetically, ultrasonically, optically, inductively, electrically, capacitively coupled, and the like) to each other. In an embodiment, circuitry includes one or more remotely located components. In an embodiment, remotely located components are operably coupled via wireless communication. In an embodiment, remotely located components are operably coupled via one or more receivers, transceivers 117, or transmitters, antennas, or the like.

In an embodiment, circuitry includes one or more network elements 110. Non-limiting examples of network elements include Local Area Networks (LANs), network gateway systems, network usage servers, Wide Area Networks (WANs), wireless base stations, wireless relays, and the like. In an embodiment, circuitry includes computer and communication platforms that include data Input/Output (I/O) transceivers 117, digital processing circuitry, data storage memories, various software components, and the like.

In an embodiment, circuitry includes one or more memory devices 109 that, for example, store instructions or data. Non-limiting examples of one or more memory devices 109 include volatile memory (e.g., Random Access Memory (RAM), Dynamic Random-Access Memory (DRAM), or the like); non-volatile memory (e.g., Read-Only Memory (ROM), Electrically Erasable Programmable Read-Only Memory (EEPROM), Flash memory, or the like); persistent memory; or the like. The one or more memory devices 109 can be coupled to, for example, one or more computing devices 108 by one or more instructions, data, or power buses.

In an embodiment, where applicable, circuitry includes peripheral devices such as Bluetooth, Wi-Fi, USB (or other wireless or wired network communication peripherals cable of data exchange with remote client and server computers), and cellular connectivity to exchange data, exchange control commands, configure the system 100, or remotely monitor system 100 parameters. In an embodiment, circuitry includes one or more user input/output components that are operably coupled to the system 100 to generate a user interface that enables access to all user configurable parameters.

In an embodiment, the system 100 includes circuitry configured to exchange queue status information with a remote client device and remote server. In an embodiment, the system 100 includes circuitry configured to acquire queue status information from a plurality of remote client devices 112. Non-limiting examples of client devices include application interface with smart devices, cell phone devices, computer devices, desktop computer devices, internet of things (IoT) devices, laptop computer devices, managed node devices, mobile client devices, notebook computer devices, remote controllers, smart devices, smart eyewear devices, smart wearable devices, tablet devices, wearable devices, and the like. In an embodiment, a client device includes a computer hardware, firmware, software, and the like that accesses a service made available by a server.

In an embodiment, the system 100 includes circuitry configured to receive one or more inputs indicative of a user priority level choice. In an embodiment, the system 100 includes circuitry configured to generate a user interface presenting a menu including one or more instances of the priority level choice choices. In an embodiment, the system 100 includes circuitry configured to generate audible instructions. In an embodiment, the system 100 includes circuitry configured to generate haptic feedback. In an embodiment, the system 100 includes circuitry including a screen and a user interface configured to allow a user to visually select settings, modes, and options and interact with a virtual menu including one or more instances of the priority level choice choices.

In an embodiment, a system 100 includes circuitry configured to initiate a discovery protocol that allows system 100 and one or more devices 110, 112 to find each other and, for example, negotiate one or more pre-shared keys to provide an encrypted secure connection. In an embodiment, individual devices are configured in hardware with a unique identifier to establish a secure IoT connection.

Referring to FIG. 1C, in an embodiment, the queue unit 102 includes a graphical user interface display 111 configured to present one or more instances of a virtual representation of the queue status 113 associated with an event. In an embodiment, the queue unit 102 includes a graphical user interface display configured to present the queue modification menu 115 including one or more instances 117 of the priority level choice. In an embodiment, the queue unit 102 includes a touch screen interface display configured to present the queue modification menu including one or more instances of the priority level choice and to enable one or more user inputs indicative a priority level choice.

In an embodiment, the queue unit 102 is configured to generate a queue priority classification for each object in the virtual queue responsive to receiving the one or more inputs indicative of a user priority level choice. In an embodiment, the object is a virtual representation of customer awaiting access to the event. In an embodiment, the object is a virtual representation of one or more passenger in a virtual queue for a flight. In an embodiment, the object is a virtual representation of passenger awaiting access to a flight.

In an embodiment, the queue unit 102 is operably coupled to a graphical user interface and computational circuitry configured to display one or more instances for modifying a queue status 105 based on a selection of priority level choice by a user. In an embodiment, the queue unit 102 includes a graphical user interface element configured to enable one or more user priority level choices.

In an embodiment, the queue unit 102 includes a voice enabled interface configured to receive audio commands and to enable one or more user priority level choices.

In an embodiment, the queue unit 102 includes computational circuitry configured to generate a queue status 105 associated with at least one airline flight. In an embodiment, the queue unit 102 is configured to classify a plurality of users as either high-priority or low-priority. In an embodiment, the queue unit 102 is configured to generate virtual representation of queue arrangement based on inputs indicative of either high-priority or low-priority status.

Referring to FIGS. 1A, 1B, 1C, and 1D, in an embodiment, a system 100 comprises a queue controller 104 configured to modify a virtual queue arrangement of a plurality of users associated with the event responsive to receiving one or more inputs indicative of a user priority level choice. In an embodiment, the queue controller 104 includes computational circuitry configured to modify a virtual queue arrangement of a plurality of users associated with the event responsive to receiving one or more inputs indicative of a user priority level choice. In an embodiment, the queue controller 104 includes circuitry configured to accept inputted payment information associated with the user priority level choice. In an embodiment, the queue controller 104 includes circuitry configured to present one or more instances to enable inputted payment information responsive to receiving the one or more inputs indicative of a user priority level choice.

In an embodiment, the queue controller 104 is configured to modify a virtual queue arrangement responsive to receiving the one or more inputs indicative of an acceptance to an offer to sell a placement in the virtual queue. In an embodiment, the queue controller 104 is configured to modify a virtual queue arrangement of a plurality of users associated with the event responsive to receiving the one or more inputs indicative of an acceptance to an offer to sell a placement in the virtual queue.

In an embodiment, the queue controller 104 is configured to generate a higher priority grouping and to electronically notify at least one member in the higher priority grouping the request to purchase a placement in the virtual queue.

In an embodiment, the queue controller 104 includes circuitry configured to accept inputted payment information. In an embodiment, the queue controller 104 is configured to facilitate payment to a seller for the placement in the virtual queue. In an embodiment, the queue controller 104 includes circuitry configured to facilitate payment to a seller for an offer to sell the placement in the virtual queue based on one or more inputs indicative of a selection of a checkout URL associated with a virtual shopping cart.

In an embodiment, a system 100 comprises an outsource unit 106 configured to broadcast a request to purchase a placement in the virtual queue. For example, in an embodiment, the outsource unit 106 includes computational circuitry having a transceiver 117 configured to broadcast to one or more client devices the request to purchase a placement in the virtual queue. In an embodiment, the outsource unit 106 is configured to modify the virtual queue arrangement of one or more of the plurality of users associated with the event responsive to receiving the one or more inputs indicative of an acceptance to an offer to sell a placement in the virtual queue.

In an embodiment, the outsource unit 106 is configured to generate a higher priority grouping and is configured to electronically notify at least one member in the higher priority grouping the request to purchase a placement in the virtual queue. In an embodiment, the outsource unit 106 is configured to facilitate payment to or from a digital wallet responsive to one or more inputs indicative of transaction for a placement in the virtual queue. In an embodiment, the outsource unit 106 is configured to facilitate payment to a seller for the placement in the virtual queue.

In an embodiment, the outsource unit 106 is configured to initiate an increase in value to a cryptocurrency wallet responsive to one or more inputs indicative of an acceptance to an offer to sell the placement in the virtual queue. In an embodiment, the outsource unit 106 is configured to initiate a cryptocurrency transfer to or from a cryptocurrency wallet based on a change in a virtual queue placement.

In an embodiment, the outsource unit 106 is configured to facilitate a virtual payment to a seller for an offer to sell the placement in the virtual queue based on one or more inputs indicative of a selection of a checkout URL associated with a virtual selling or purchasing cart.

Referring to FIG. 2, in an embodiment, a system 100 comprises means 202 for generating a queue status 105 associated with an event and for presenting a virtual queue modification menu 101 including one or more instances of a priority level choice 103. In an embodiment, a system 100 comprises means 204 for modifying a virtual queue arrangement of a plurality of users associated with the event responsive to receiving a user priority level choice. In an embodiment, a system 100 comprises means 206 for broadcasting a request to purchase a placement in the virtual queue.

In an embodiment, the means 202 for generating the queue status 105 associated with the event and for presenting the virtual queue modification menu 101 includes computational circuitry 201 having a processor operably coupled to a graphical user interface display configured to present one or more instances of a virtual representation of the queue status 105 associated with an event. In an embodiment, the means 202 for generating the queue status 105 associated with the event and for presenting the virtual queue modification menu 101 includes computational circuitry 203 having a processor operably coupled to a graphical user interface display configured to present the queue modification menu 101 including one or more instances of the priority level choice.

In an embodiment, the means 202 for generating the queue status 105 associated with the event and for presenting the virtual queue modification menu 101 includes computational circuitry having a processor operably coupled to a touch screen interface display configured to present the queue modification menu 101 including one or more instances of the priority level choice and to enable one or more user inputs indicative a priority level choice.

In an embodiment, the means 202 for generating the queue status 105 associated with the event and for presenting the virtual queue modification menu 101 includes computational circuitry having a processor configured to generate a queue priority classification for each object in the virtual queue responsive to receiving the one or more inputs indicative of a user priority level choice. In an embodiment, the object is a virtual representation of customer awaiting access to the event. In an embodiment, the object is a virtual representation of one or more passenger in a virtual queue for a flight. In an embodiment, the object is a virtual representation of passenger awaiting access to a flight.

In an embodiment, the means 202 for generating the queue status 105 associated with the event and for presenting the virtual queue modification menu 101 includes computational circuitry having a processor operably coupled to graphical user interface and computational circuitry configured to display one or more instances for modifying a queue status 105 based on a selection of priority level choice by a user. In an embodiment, the means 202 for generating the queue status 105 associated with the event and for presenting the virtual queue modification menu 101 includes computational circuitry having a processor operably coupled a graphical user interface element configured to enable one or more user priority level choices. In an embodiment, the means 202 for generating the queue status 105 associated with the event and for presenting the virtual queue modification menu 101 includes computational circuitry having a processor operably coupled a voice enabled interface configured to receive audio commands and to enable one or more user priority level choices.

In an embodiment, the means 202 for generating the queue status 105 associated with the event and for presenting the virtual queue modification menu 101 includes computational circuitry having a processor configured to generate a queue status 105 associated with at least one airline flight. In an embodiment, the means 202 for generating the queue status 105 associated with the event and for presenting the virtual queue modification menu 101 includes computational circuitry having a processor configured to classify a plurality of users as either high-priority or low-priority. In an embodiment, the means 202 for generating the queue status 105 associated with the event and for presenting the virtual queue modification menu 101 includes computational circuitry having a processor configured to generate virtual representation of queue arrangement based on inputs indicative of either high-priority or low-priority status.

In an embodiment, the means 204 for modifying a virtual queue arrangement of a plurality of users associated with the event includes computational circuitry 205 having a processor configured to accept inputted payment information associated with the user priority level choice. In an embodiment, the means 204 for modifying a virtual queue arrangement of a plurality of users associated with the event includes computational circuitry having a processor configured to present one or more instances to enable inputted payment information responsive to receiving the one or more inputs indicative of a user priority level choice.

In an embodiment, the means 204 for modifying a virtual queue arrangement of a plurality of users associated with the event includes computational circuitry having a processor configured to modify the virtual queue arrangement responsive to receiving the one or more inputs indicative of an acceptance to an offer to sell a placement in the virtual queue. In an embodiment, the means 204 for modifying a virtual queue arrangement of a plurality of users associated with the event includes computational circuitry having a processor configured to modify the virtual queue arrangement of a plurality of users associated with the event responsive to receiving the one or more inputs indicative of an acceptance to an offer to sell a placement in the virtual queue. In an embodiment, the means 204 for modifying a virtual queue arrangement of a plurality of users associated with the event includes computational circuitry having a processor configured to generate a higher priority grouping and to electronically notify at least one member in the higher priority grouping the request to purchase a placement in the virtual queue.

In an embodiment, the means 204 for modifying a virtual queue arrangement of a plurality of users associated with the event includes computational circuitry having a processor configured to accept inputted payment information. In an embodiment, the means 204 for modifying a virtual queue arrangement of a plurality of users associated with the event includes computational circuitry having a processor configured to facilitate payment to a seller for the placement in the virtual queue. In an embodiment, the means 204 for modifying a virtual queue arrangement of a plurality of users associated with the event includes computational circuitry having a processor configured to facilitate payment to a seller for an offer to sell the placement in the virtual queue based on one or more inputs indicative of a selection of a checkout URL associated with a virtual shopping cart.

In an embodiment, a system 100 comprises means 206 for broadcasting a request to purchase a placement in the virtual queue. In an embodiment, the means 206 for broadcasting the request to purchase the placement in the virtual queue includes computational circuitry having a transceiver 117 configured to broadcast to one or more client devices the request to purchase a placement in the virtual queue. In an embodiment, the means 206 for broadcasting the request to purchase the placement in the virtual queue includes computational circuitry having a processor configured to modify the virtual queue arrangement of one or more of the plurality of users associated with the event responsive to receiving the one or more inputs indicative of an acceptance to an offer to sell a placement in the virtual queue.

In an embodiment, the means 206 for broadcasting the request to purchase the placement in the virtual queue includes computational circuitry having a processor configured to generate a higher priority grouping and is configured to electronically notify at least one member in the higher priority grouping the request to purchase a placement in the virtual queue. In an embodiment, the means 206 for broadcasting the request to purchase the placement in the virtual queue includes computational circuitry having a processor configured to facilitate payment to a digital wallet responsive to one or more inputs indicative of transaction for a placement in the virtual queue. In an embodiment, the means 206 for broadcasting the request to purchase the placement in the virtual queue includes computational circuitry having a processor configured to facilitate payment to a seller for the placement in the virtual queue.

In an embodiment, the means 206 for broadcasting the request to purchase the placement in the virtual queue includes computational circuitry having a processor configured to initiate an increase in value to a cryptocurrency wallet responsive to one or more inputs indicative of an acceptance to an offer to sell the placement in the virtual queue. In an embodiment, the means 206 for broadcasting the request to purchase the placement in the virtual queue includes computational circuitry having a processor configured to initiate a cryptocurrency transfer to or from a cryptocurrency wallet based on a change in a virtual queue placement.

In an embodiment, the means 206 for broadcasting the request to purchase the placement in the virtual queue includes computational circuitry having a processor configured to facilitate a virtual payment to a seller for an offer to sell the placement in the virtual queue based on one or more inputs indicative of a selection of a checkout URL associated with a virtual selling or purchasing cart.

FIG. 3A shows a device 302 for accessing and managing a virtual queue for an event or services. In an embodiment, during use, device 302 includes computational circuitry configured to generate a virtual airline sell queue 304 indicative of bid requests from the airline bid queue for a specific flight by priority class. In an embodiment, passengers with seats on a flight accessing the sell queue are presented with available bids 306, 308 generated from the bid queue by priority class. In an embodiment, the virtual sell queue menu 310 enables access to other bid requests generated from the bid queue for other applicable flights. In an embodiment, the virtual sell queue menu 304 presents passenger with their purchased seat information 312 by priority class available for submission to the sell queue. In an embodiment, passenger can view the virtual open requests 314 and sell applicable priority class seats. Seats sold will be released via the release queue. In an embodiment, a release queue will enable booking adjustments and payment debit and credit execution processing.

FIG. 3B shows a device 302 for accessing and managing a virtual queue for an event or services. In an embodiment, the device 302 includes computational circuitry configured to generate a virtual airline bid selection menu 316 including one or more instances 318 of available flights (events) within the applicable time period, with priority level choices 320 for each event. In an embodiment, the device 302 includes computational circuitry configured to generate to presents options 322 virtually indicative of seats that one or more passengers have submitted via a release queue and are available for open bid (25 indicated).

In an embodiment, the device 302 includes computational circuitry including one or more displays that allow users to view and bid 324 on released seats by priority level by flight. For a specific flight (event ABC) a customer is able to complete a bid selection by selecting specific priority level seats and submitting their request to bid. In an embodiment, an airline flight queue will process the bid requiring additional user input within the bid queue and review process. In an embodiment, the notification queue will enable a passenger to receive notification for bid review. In an embodiment, passenger will access the virtual release queue to review and continue the transaction processing. In an embodiment, a release queue includes computational circuitry that enables booking adjustments and payment debit and credit execution processing.

FIGS. 3C and 3D show a device 352 for accessing and managing a virtual queue for reservations or restaurant services. in an embodiment, the device 302 is configured to presents a virtual restaurant bid selection menu including one or more instances of restaurants and tables available for bid in the applicable time period. For example, in an embodiment, the device 302 includes computational circuitry configured to generate a virtual restaurant bid selection menu including one or more instances of restaurants and tables available for bid in the applicable time period.

In an embodiment, the restaurant queue presents options virtually indicative of tables that a reservation ‘owner’ has submitted via a release queue and are available for open bid. In an embodiment, during use, a customer can view and bid on released reservations by priority level (location). In an embodiment, for a specific reservation a customer is able to complete a bid selection by selecting specific tables and submitting their request to bid. In an embodiment, the restaurant queue will process the bid requiring additional user input within the bid queue and review process. In an embodiment, the notification queue will enable a reservation ‘owner’ to receive notification for bid review. In an embodiment, a reservation ‘owner’ will access the virtual release queue to review and continue transaction processing. In an embodiment, a release queue will enable booking adjustments and payment debit and credit execution processing.

FIGS. 4A, 4B, and 4C show a method 400. At 410, the method 400 includes presenting a virtual queue modification menu 101 including one or more instances of a priority level choice 103. At 412, presenting the virtual queue modification menu 101 including one or more instances of the priority level choice includes generating a display of one or more instances of a virtual representation of the queue status 105 associated with an event. At 414, presenting the virtual queue modification menu 101 including one or more instances of the priority level choice includes presenting the queue modification menu 101 including one or more instances of the priority level choice and enabling one or more user inputs indicative a priority level choice. At 416, presenting the virtual queue modification menu 101 including one or more instances of the priority level choice includes generating a queue priority classification for each object in the virtual queue responsive to receiving the one or more inputs indicative of a user priority level choice.

At 418, presenting the virtual queue modification menu 101 including one or more instances of the priority level choice includes generating a queue priority classification for each customer awaiting access to the event. At 420, presenting the virtual queue modification menu 101 including one or more instances of the priority level choice includes generating a queue priority classification for each passenger in a virtual queue for a flight. At 422, presenting the virtual queue modification menu 101 including one or more instances of the priority level choice includes generating a queue priority classification for each passenger awaiting access to a flight.

At 424, presenting the virtual queue modification menu 101 including one or more instances of the priority level choice includes electronically displaying one or more instances for modifying a queue status 105 based on a selection of priority level choice by a user. At 426, presenting the virtual queue modification menu 101 including one or more instances of the priority level choice includes enabling one or more user priority level choices. At 428, the method 400 includes modifying a virtual queue arrangement of a plurality of users associated with the event responsive to receiving the one or more inputs indicative of a user priority level choice. At 430, modifying the virtual queue arrangement of the plurality of users associated with the event responsive to receiving the one or more inputs indicative of a user priority level choice includes modifying the virtual queue arrangement responsive to receiving the one or more inputs indicative of an acceptance to an offer to sell a placement in the virtual queue. At 432, modifying the virtual queue arrangement of the plurality of users associated with the event responsive to receiving the one or more inputs indicative of a user priority level choice includes modifying the virtual queue arrangement of a plurality of users associated with the event responsive to receiving the one or more inputs indicative of an acceptance to an offer to sell a placement in the virtual queue.

At 434, the method 400 includes receiving audio commands; and enabling one or more user priority level choices. At 436, the method 400 includes accepting inputted payment information associated with the user priority level choice. At 438, the method 400 includes presenting one or more instances to enable inputted payment information responsive to receiving the one or more inputs indicative of a user priority level choice.

At 440, the method 400 includes generating a higher priority grouping; and electronically notify at least one member in the higher priority grouping the request to purchase a placement in the virtual queue. At 442, the method 400 includes accepting inputted payment information. At 444, the method 400 includes facilitating payment to a seller for the placement in the virtual queue. At 446 the method 400 includes facilitating payment to a seller for an offer to sell the placement in the virtual queue based on one or more inputs indicative of a selection of a checkout URL associated with a virtual shopping cart.

At 448, the method 400 includes broadcasting a request to purchase a placement in the virtual queue. At 450, broadcasting a request to purchase a placement in the virtual queue includes broadcasting to one or more client devices the request to purchase a placement in the virtual queue.

At 452, the method 400 includes modifying the virtual queue arrangement of one or more of the plurality of users associated with the event responsive to receiving the one or more inputs indicative of an acceptance to an offer to sell a placement in the virtual queue. At 454, the method 400 includes generating a higher priority grouping; and electronically notifying at least one member in the higher priority grouping the request to purchase a placement in the virtual queue. At 456, the method 400 includes facilitating payment to a digital wallet responsive to one or more inputs indicative of transaction for a placement in the virtual queue.

At 458, the method 400 includes facilitating payment to a seller for the placement in the virtual queue. At 460, the method 400 includes initiating an increase in value to a cryptocurrency wallet responsive to one or more inputs indicative of an acceptance to an offer to sell the placement in the virtual queue. At 462, the method 400 includes initiating a cryptocurrency transfer to or from a cryptocurrency wallet based on a change in a virtual queue placement. At 464, the method 400 includes facilitating a virtual payment to a seller for an offer to sell the placement in the virtual queue based on one or more inputs indicative of a selection of a checkout URL associated with a virtual selling or purchasing cart.

FIG. 5 shows a method 500. At 510, the method 500 includes generating a virtual queue arrangement of a plurality of users associated with an event. At 512, the method 500 includes communicating a virtual queue modification menu 101 including one or more instances of a priority level choice 103. At 514, the method 500 includes receiving one or more inputs indicative of a user priority level choice.

At 516, the method 500 includes changing a virtual queue arrangement of a plurality of users associated with the event responsive to receiving the one or more inputs indicative of a user priority level choice. At 518, the method 500 includes changing the virtual queue arrangement of one or more of the plurality of users associated with the event responsive to receiving the one or more inputs indicative of an acceptance to an offer to sell a placement in the virtual queue.

At 520, the method 500 includes broadcasting a request to buy a placement in the virtual queue. At 522, the method 500 includes broadcasting to one or more client devices the request to buy a placement in the virtual queue.

At 524, the method 500 includes generating a higher priority grouping for a plurality of users associated with the event. At 526, the method 500 includes electronically notifying at least one member in the higher priority grouping a request to buy a placement in the virtual queue. At 528, the method 500 includes electronically notifying at least one member in the higher priority grouping a request to buy a placement in the virtual queue. At 530, the method 500 includes electronically notifying at least one member in the higher priority grouping a request to buy a placement in the virtual queue. At 532, the method 500 includes facilitating payment to a digital wallet responsive to receiving one or more inputs indicative of transaction for a placement in the virtual queue. For example, User 1 and Passenger 1 have setup virtual accounts in the application to allow money exchange. User 1 submits a request for a seat on Passenger 1s flight via an application. Passenger 1 receives notification via an application that User 1 is seeking a seat on the flight that Passenger 1 is currently booked on. Passenger 1 releases the seat for bid via the application. User 1 receives notification that a seat in User 1 s requested class is available for bidding. User 1 bids a monetary amount for the seat via the application and awaits a response. Passenger 1 accepts the bid via the application. Backend servers will process the transaction and issue the seat to User 1. User 1 s virtual account is deducted for the accepted bid amount and Passenger 1 s virtual account is credited.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application.

In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure.

In addition, the mechanisms of the subject matter described herein are capable of being distributed as a program product in a variety of forms, and that an illustrative embodiment of the subject matter described herein applies regardless of the signal-bearing medium used to actually carry out the distribution. Non-limiting examples of a signal-bearing medium include the following: a recordable type medium such as magnetic data storage media, non-volatile memory drive “Solid state drive,” any potable data storage media, a hard disk drive, a Compact Disc (CD), a Digital Video Disk (DVD), a digital tape, a computer memory, etc.; and a transmission type medium such as a program distribution via remote download over any wired or wireless network.

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A system, comprising:
a queue unit including computational circuitry configured to generate a queue status associated with an event and to present a queue modification menu including one or more instances of a priority level choice; and
a queue controller including computational circuitry configured to modify objects in a virtual queue of a plurality of users associated with the event responsive to receiving one or more inputs indicative of a user priority level choice.

2. The system of claim 1, further comprising:
an outsource unit configured to broadcast a request to purchase a placement in a virtual queue.

3. The system of claim 2, wherein the outsource unit includes computational circuitry having a transceiver configured to broadcast to one or more client devices the request to purchase a placement in the virtual queue.

4. The system of claim 2, wherein the outsource unit is configured to modify the virtual queue arrangement of one or more of the plurality of users associated with the event responsive to receiving the one or more inputs indicative of an acceptance to an offer to sell a placement in the virtual queue.

5. The system of claim 2, wherein the outsource unit is configured to generate a higher priority grouping and is configured to electronically notify at least one member in the higher priority grouping the request to purchase a placement in the virtual queue.

6. A system, comprising:
means for generating a queue status associated with an event and for presenting a virtual queue modification menu including one or more instances of a priority level choice; and
means for modifying objects in a virtual queue arrangement of a plurality of users associated with the event responsive to receiving a user priority level choice.

7. The system of claim 6, wherein the means for generating the queue status associated with the event and for presenting the virtual queue modification menu includes computational circuitry having a processor operably coupled to a graphical user interface display configured to present one or more instances of a virtual representation of the queue status associated with an event.

8. The system of claim 6, wherein the means for generating the queue status associated with the event and for presenting the virtual queue modification menu includes computational circuitry having a processor operably coupled to a graphical user interface display configured to present the queue modification menu including one or more instances of the priority level choice.

9. The system of claim 6, wherein the means for generating the queue status associated with the event and for presenting the virtual queue modification menu includes computational circuitry having a processor operably coupled to a touch screen interface display configured to present the queue modification menu including one or more instances of the priority level choice and to enable one or more user inputs indicative a priority level choice.

10. The system of claim 6, wherein the means for generating the queue status associated with the event and for presenting the virtual queue modification menu includes computational circuitry having a processor configured to generate a queue priority classification for each object in the virtual queue responsive to receiving one or more inputs indicative of a user priority level choice.

11. The system of claim 10, wherein the object is a virtual representation of customer awaiting access to the event.

12. The system of claim 10, wherein the object is a virtual representation of one or more passenger in a virtual queue for a flight.

13. A method, comprising:
generating a virtual queue arrangement of a plurality of users associated with an event;
communicating a virtual queue modification menu including one or more instances of a priority level choice; and
receiving one or more inputs indicative of a user priority level choice.

14. The method of claim 13, further comprising:
changing a virtual queue arrangement of a plurality of users associated with the event responsive to receiving the one or more inputs indicative of a user priority level choice.

15. The method of claim 13, further comprising:
changing the virtual queue arrangement of one or more of the plurality of users associated with the event responsive to receiving the one or more inputs indicative of an acceptance to an offer to sell a placement in the virtual queue.

16. The method of claim 13, further comprising:
broadcasting a request to buy a placement in the virtual queue.

17. The method of claim 13, further comprising:
broadcasting to one or more client devices a request to buy a placement in the virtual queue.

18. The method of claim 13, further comprising:
generating a higher priority grouping for a plurality of users associated with the event; and
electronically notifying at least one member in the higher priority grouping a request to buy a placement in the virtual queue.

19. The method of claim 13, further comprising:
generating a higher priority grouping associated with the event; and
electronically notifying at least one member in the higher priority grouping a request to buy a placement in the virtual queue.

20. The method of claim 13, further comprising:
facilitating payment to a digital wallet responsive to receiving one or more inputs indicative of transaction for a placement in the virtual queue.
